(19) United States
(12) Patent Application Publication
(10) Pub. No.: US 2009/0166506 A1
(43) Pub. Date: Jul. 2, 2009

(54) Engine Mount With Two Piece Core

(75) Inventors: Raise Ahmed, Northville, MI (US); Robert C. Michniewicz, Livonia, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/968,530

(22) Filed: Jan. 2, 2008

(51) Int. Cl. F16M 5/00

(52) U.S. Cl. 248/634

(57) ABSTRACT

An engine mount, includes a pair of identical core members each having an aperture extending there through and having anti-rotation features engaging one another. A pair of elastomeric bushings are provided on an exterior surface of respective ones of the pair of core members. A pair of outer rings surround respective ones of the elastomeric bushings. An engine bracket has a base portion adapted to be mounted to an engine and an annular body receiving the pair of outer rings. A frame bracket has a mount portion adapted to be attached to a vehicle frame and first and second arms extending from the mount portion and disposed on opposite ends of the pair of identical core members.

### FIELD

The present disclosure relates to engine mounts and more particularly, to an engine mount having a two-piece core and a rubber bushing.

### BACKGROUND

The statements in this section merely provide background information related to the present disclosure and may not constitute prior art.

A vehicle engine is commonly mounted in a vehicle by an engine mount that extends between the vehicle frame and the engine. The engine mounts are particularly designed to dampen vibrations that are imparted to the vehicle frame and isolate the engine from the vibrations of the frame. Current engine mount designs can be complicated and expensive requiring complicated manufacturing processes and the use of multiple different components.

### SUMMARY

An engine mount, includes a pair of identical core members each having an aperture extending there through and having anti-rotation features engaging one another. A pair of elastomeric bushings are provided on an exterior surface of respective ones of the pair of core members. A pair of outer rings surround respective ones of the elastomeric bushings. An engine bracket has a base portion adapted to be mounted to an engine and an annular body receiving the pair of outer rings. A frame bracket has a mount portion adapted to be attached to a vehicle frame and first and second arms extending from the mount portion and disposed on opposite ends of the pair of identical core members.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an engine mount according to the principles of the present invention;

FIG. 2 is a cross-sectional view of the engine mount taken along line 2-2 of FIG. 1;

FIG. 3 is a perspective view of a core element of the engine mount;

FIG. 4 is a perspective view of a pair of core elements shown in an engaged position;

FIG. 5 is a perspective view of a core element with an over-molded elastomeric bushing; and

FIG. 6 is a perspective view of a core element with an over-molded elastomeric bushing and an outer ring surrounding the bushing.

### DETAILED DESCRIPTION

The following description is merely exemplary in nature and is not intended to limit the present disclosure, application, or uses. It should be understood that throughout the drawings, corresponding reference numerals indicate like or corresponding parts and features.

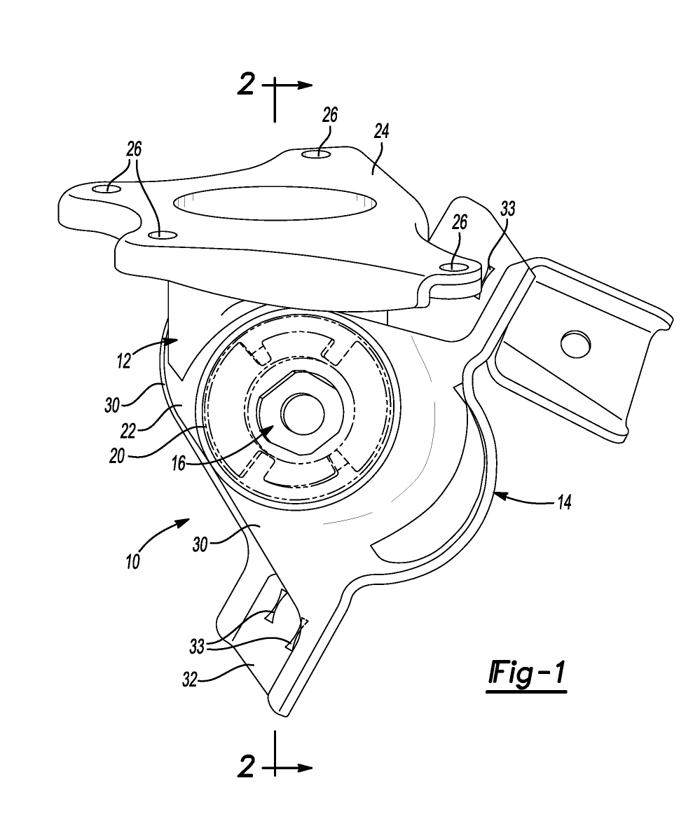

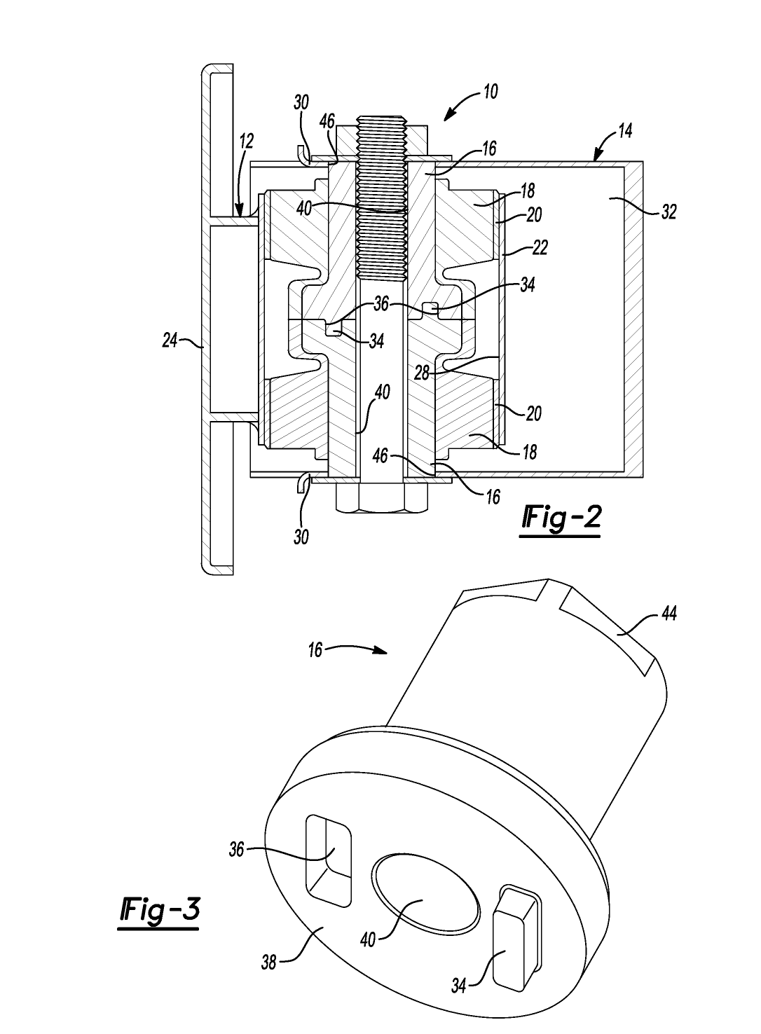

With reference to FIGS. 1 and 2, an engine mount 10 according to the principles of the present disclosure will now be described. The engine mount 10 includes an engine mount bracket 12 adapted to be mounted to an engine and a frame mount bracket 14 adapted to be mounted to a frame. As best shown in FIG. 2, the engine mount 10 includes a pair of core members 16 each having an elastomeric material 18 molded to or otherwise assembled on the core members 16. A pair of generally cylindrical outer rings 20 surround the elastomeric material 18 and are received in an annular body 22 of the engine mount bracket 12.

The engine mount bracket 12 includes a base portion 24 adapted to be mounted to an engine. By way of example, the engine mount bracket 12 includes a plurality of bolt holes 26 for receiving threaded fasteners for mounting the engine mount bracket 12 to an engine. The annular body 22 is mounted to the base portion 24 of the engine mount bracket 12. The annular body 22 generally defines a cylindrical opening 28 for receiving the outer rings 20 therein.

The frame mount bracket 14 includes a pair of arms 30 which are mounted to opposite ends of the pair of core members 16. The pair of arms 30 extend from a base portion 32 adapted to be mounted to a vehicle frame. By way of example, the frame mount bracket 14 includes a plurality of bolt holes 33 for receiving threaded fasteners for mounting the frame mount bracket 14 to a vehicle frame.

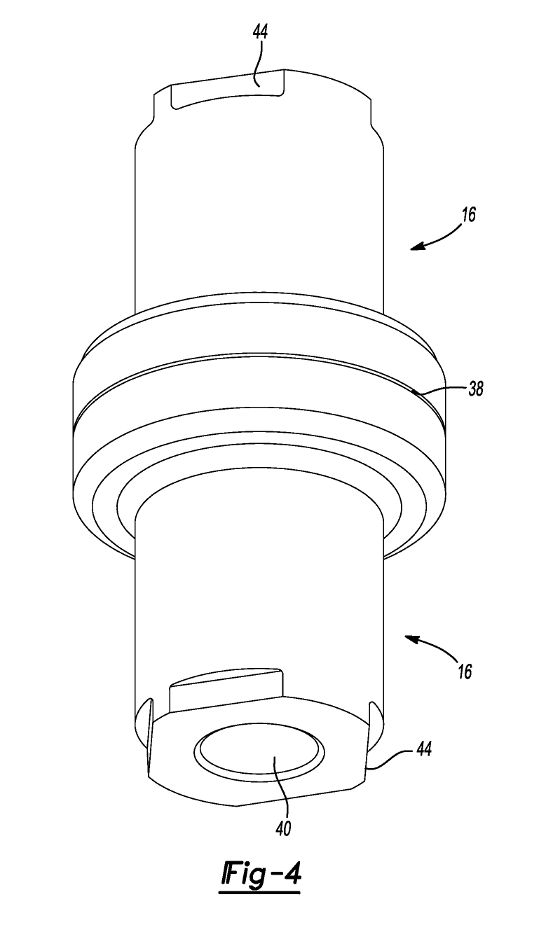

The core members 16 can be identical to one another and can include anti-rotation features such as a protruding element 34 and a recess 36 (best shown in FIG. 3) that can be engaged with one another as illustrated in FIGS. 2 and 4. The core elements 16 can include an engagement face 38 on which, the anti rotation features can be formed. The core elements 16 can be formed from aluminum or other metallic material or from other engineering materials that have sufficient strength to withstand the necessary forces. Examples of such engineering materials can include fiber reinforced plastics and ceramic materials. The core elements 16 are provided with an aperture 40 extending there through for receiving a bolt 42 therein for securing the arms 30 on opposite ends of the core members 16, as illustrated in FIG. 2. The core elements 16 can include a polygonal end portion 44, on an opposite end from said engagement face 38, for providing a predetermined orientation of the core members 16 with respect to the frame mount bracket 14 which is provided with corresponding polygonal shaped apertures 46 in the arms 30 to insure that the core members 16 are properly oriented.

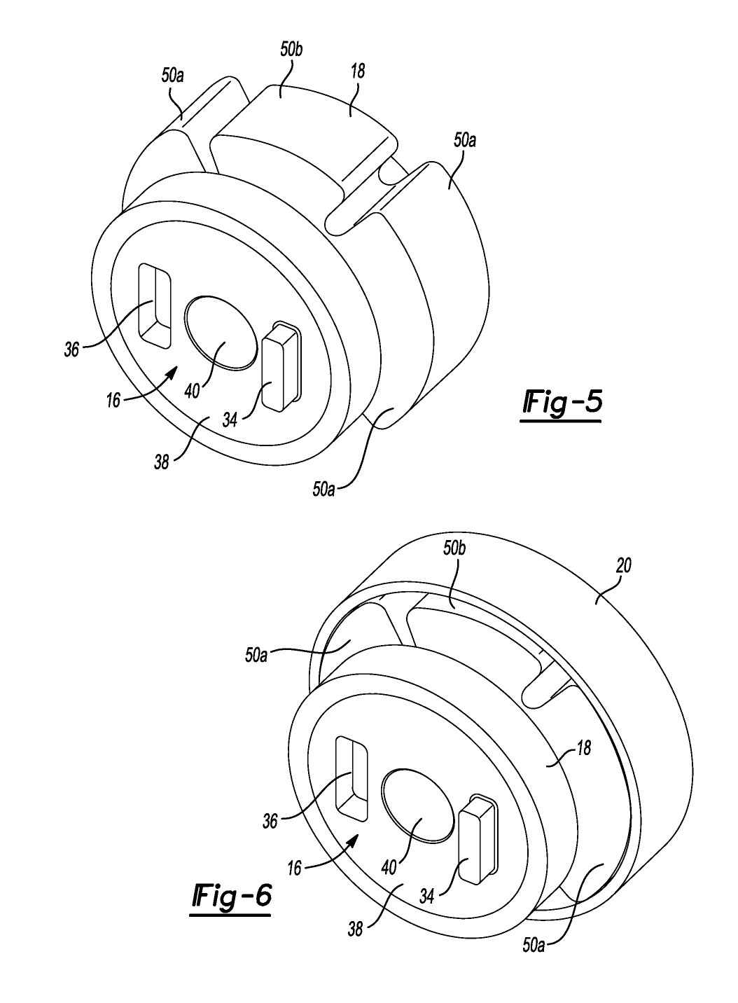

The elastomeric material 18 is over-molded or otherwise assembled onto the core members 16. The elastomeric material 18 can include a plurality of radially projecting lobes 50 (only three of which are shown). The lobes 50 can have different shapes and sizes in order to provide different dampening characteristics in different directions. In the embodiment illustrated in FIGS. 5 and 6, the lobes 50a extend to a radially outermost position in engagement with the outer ring 20 while the lobe 50b has a smaller radial extent and is spaced from the outer ring 20.

With the engine mount design of the present disclosure, the core elements 16 having an identical configuration, allows the mount to be made with high volume, with a simple manufacturing process and at low cost.

What is claimed is:

1. An engine mount, comprising:
a pair of identical core members each having an aperture extending there through and having anti-rotation features engaging one another;
a pair of elastomeric bushings on an exterior surface of respective ones of said pair of core members; and
a pair of outer rings surrounding respective ones of said elastomeric bushings.

2. The engine mount according to claim 1, wherein said pair of identical core members are made from aluminum.

3. The engine mount according to claim 1, further comprising an engine bracket having a base portion adapted to be mounted to an engine and annular body receiving said pair of outer rings.

4. The engine mount according to claim 3, further comprising a frame bracket having a mount portion adapted to be attached to a vehicle frame and first and second arms extending from said mount portion and disposed on opposite ends of said pair of identical core members, said first and second arms each including an aperture therein.

5. The engine mount according to claim 4, further comprising a fastener extending through said apertures in said frame bracket and said core members.

6. The engine mount according to claim 1, wherein said anti-rotation features include at least one protruding feature and at least one recess feature on each of said core members.

7. The engine mount according to claim 1, wherein said pair of elastomeric bushings include a plurality of radially outwardly extending lobes.

8. The engine mount according to claim 7, wherein at least two of said radially outwardly extending lobes of said elastomeric bushings engage said outer ring and at least one of said radially outwardly extending lobes is spaced from an inner surface of said outer ring.

9. The engine mount according to claim 1, wherein said anti-rotation features provide joint capacity in a final assembly state.

10. The engine mount according to claim 1, wherein said pair of identical core members are made from metallic material.

11. The engine mount according to claim 1, wherein said pair of identical core members are made from engineering materials that have sufficient strength to withstand the necessary forces.
